(19) United States
(12) Patent Application Publication
(10) Pub. No.: US 2017/0154519 A1
(43) Pub. Date: Jun. 1, 2017

(54) Alarming Method, Terminal, and Storage Medium

(71) Applicant: XI'AN ZHONGXING NEW SOFTWARE CO., LTD., Xi'An City, Shaanxi Province (CN)

(72) Inventors: Gang LIU, Xi'An (CN); Junxuan LIN, Xi'An (CN); Jian CHEN, Xi'An (CN)

(21) Appl. No.: 15/314,097

(22) PCT Filed: Dec. 10, 2014
(86) PCT No.: PCT/CN2014/093491

§ 371 Date: Nov. 28, 2016

(30) Foreign Application Priority Data
May 28, 2014 (CN) 201410230921.7

(51) Int. Cl. G08B 21/18; G10L 15/30; G10L 25/51; G10L 15/02; G10L 15/22

(52) U.S. Cl. CPC G08B 21/18; G10L 15/02; G10L 15/22; G10L 25/51; G10L 15/30

(57) ABSTRACT

An alarm method, a terminal, and a storage medium are provided. The method may include: after a terminal receiving a first voice signal, the terminal matches the first voice signal with a preset voice template (S101); when the first voice signal successfully matches the preset voice template, the terminal extracts a voiceprint of the first voice signal (S102); the terminal matches the voiceprint of the first voice signal with a preset voiceprint template (S103); and when the voiceprint of the first voice signal successfully matches the preset voiceprint template, the terminal generates an alarm (S104).

### TECHNICAL FIELD

The present document relates to the field of alarm processing technologies, and specifically relates to an alarm method, a terminal and a storage medium.

### BACKGROUND

At present, mobile terminal devices on the market are provided with alarm functions. For example, people can press an emergency-call button arranged on a terminal to give an alarm, or press an emergency-call switch to start up quickly and to give an alarm.

However, when a user cannot manually operate the terminal because of limitations of objective conditions, the above-mentioned alarm functions cannot be realized successfully.

### SUMMARY

To solve the above mentioned technical problem, embodiments of the present document provide an alarm method, a terminal and a storage medium for controlling the terminal to call for help and alarm through the voice of the user, herein the operations are easy, convenient and efficient.

Technical solutions of the present document may be realized by following.

In the first aspect, embodiments of the present document provide an alarm method, the method includes:

after the terminal receiving a first voice signal, the terminal matching the first voice signal with a preset voice template;

when the first voice signal matches the preset voice template successfully, the terminal extracting a voiceprint of the first voice signal;

the terminal matching the voiceprint of the first voice signal with a preset voiceprint template; and

when the voiceprint of the first voice signal matches the preset voiceprint template successfully, the terminal generating an alarm.

According to the first possible implementation, in combination with the first aspect, the terminal matching the voiceprint of the first voice signal with a preset voiceprint template includes:

matching by the terminal the voiceprint of the first voice signal with a voiceprint template prestored in the terminal; or

after sending a matching request to a matching server, receiving by the terminal a matching result sent from the matching server. The matching request includes the voiceprint of the first voice signal and the matching result is obtained after the matching server matches the voiceprint of the first voice signal with a voiceprint template prestored in the matching server.

According to the second possible implementation, combing the first aspect, the terminal generating the alarm includes:

sending by the terminal alarm information to a preset target terminal; and/or

obtaining by the terminal current position information of the terminal and transmitting the current position information to the preset target terminal.

According to the third possible implementation, combing the second possible implementation, the terminal sending the alarm information to the preset target terminal includes:

sending by the terminal an alarm message to the preset target terminal; or

dialing by the terminal the preset target terminal.

According to the forth possible implementation, combing the second possible implementation, the alarm information includes audio message or video information for current circumstance of the terminal.

In the second aspect, embodiments of the present document provide a terminal, the terminal includes a receiving unit, a receiving unit, an extracting unit, and an alarm unit.

Herein, the receiving unit is arranged to receive a first voice signal.

The matching unit is arranged to match the first voice signal with a preset voice template after the receiving unit has received the first voice signal.

The extracting unit is arranged to extract a voiceprint of the first voice signal, when the matching unit determines that first voice signal matches the preset voice template successfully.

The matching unit is further arranged to match the voiceprint of the first voice signal extracted by the extracting unit with a preset voiceprint template.

The alarm unit is arranged to generate an alarm when the matching unit determines that the voiceprint of the first voice signal matches the preset voiceprint template successfully.

According to the first possible implementation, combing the second aspect, the matching unit is arranged to match the voiceprint of the first voice signal with a voiceprint template prestored in the terminal; or

the matching unit comprises a sending module and a receiving module.

Herein, the sending module is arranged to send a matching request to a matching server, the matching request comprising the voiceprint of the first voice signal, and

the receiving module is arranged to receive a matching result sent from the matching server, and the matching result being obtained after the matching server matches the voiceprint of the first voice signal with the prestored voiceprint template in the matching server.

According to the second possible implementation, combing the second aspect, the alarm unit is arranged to:

send alarm information to a preset target terminal; and/or

obtain current position information of the terminal and transmit the current position information of the terminal to the preset target terminal.

According to the third possible implementation, combing the second possible implementation, the alarm unit is further arranged to:

send an alarm message to the preset target terminal or dial the preset target terminal.

According to the forth possible implementation, combing the second possible implementation, the alarm information includes information about recorded audio or video for current circumstance of the terminal.

Embodiments of the present document provide terminal further provides a computer storage medium, and this computer storage medium stores a computer program for executing the aforementioned alarm method.

The alarm method and the terminal according to the embodiments of the present document confirm whether the user is in the state in which the alarm is needed by performing voice template matching and voiceprint template matching on the received first voice signal, and generates the alarm, which realizes calling for help and alarm by controlling the terminal through the voice of the user, being easy to operate, convenient, and efficient.

### DESCRIPTION OF THE DRAWINGS

FIG. 1 is a flow chart of an alarm method according to an embodiment of the present document.

FIG. 2 is a structure schematic diagram of a terminal according to an embodiment of the present document.

FIG. 3 is a structure schematic diagram of another terminal according to an embodiment of the present document.

### DETAILED EMBODIMENTS

Technical solutions in embodiments of the present document will be clearly and fully described below in combination with drawings in embodiments of the present document.

A basic thought in the embodiments of the present document is that a terminal generates an alarm by receiving a specific voice signal of a user and after confirming an identity of the user via identifying a voiceprint of the specific voice signal. Therefore, the user can send alarm information without manually operations, so as to ensure the user's own safety in the case that the user cannot operate the terminal manually.

It can be understood that, the terminal can be a mobile device having a communication function. For example, the terminal can be, but is not limited to, a smart phone, a tablet computer, a palm computer, a laptop computer, a wearable electronic device, and so on.

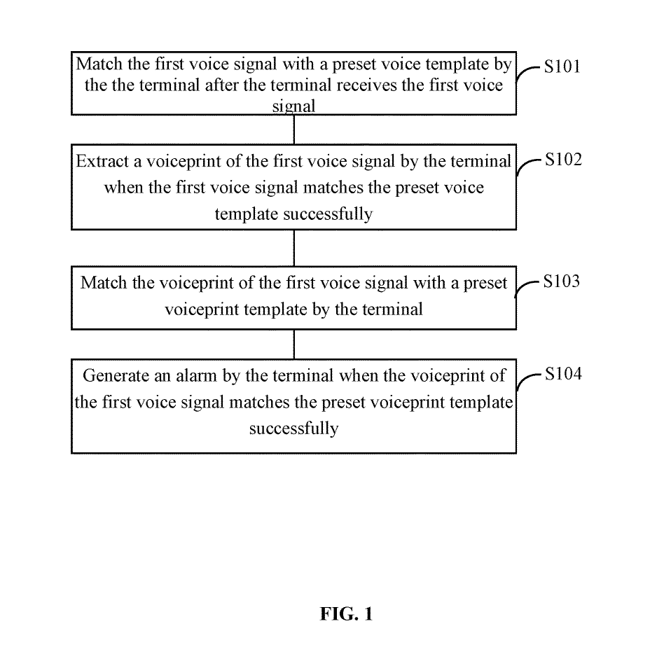

Based on the above-mentioned basic thought, FIG. 1 shows a flow chart of an alarm method according to an embodiment of the present document. The method can be applied to a terminal device. As shown in FIG. 1, the method can include:

S101, after the terminal receives the first voice signal, the terminal matches the first voice signal with a preset voice template.

Exemplarily, the preset voice template can be prestored in the terminal by the user. The first voice signal can be voices issued in some specific scenes of that the user cannot operate the terminal manually. In an embodiment, the specific scenes can include, but are not limited to, the scene of the user being threatened by someone and cannot take out a mobile phone to alarm, the scene of the user having accidental injury resulted in that hands of the user cannot move, and so on. In theses specific scenes, because the user cannot use the hands to operate the terminal for alarming and calling for help, the user can only use the terminal for alarming by voice controlling.

In one implementation of the embodiment, a detailed realization process of S101 can include: the terminal buffering the first voice signal detected by a microphone of the terminal by a digital signal processor (DSP), extracting help content included in the first voice signal by the way of pattern recognition, matching the extracted help content with the preset voice template, and determining whether to wake up a central processing unit (CPU) for executing subsequent voiceprint recognition according to the matching result. It can be understood that, when the match fails, the DSP would ignore the received voice signal at this time, and make the microphone continue listening.

S102, when the first voice signal matches the preset voice template successfully, the terminal extracts a voiceprint of the first voice signal.

As one implementation method in the embodiment, in combination with the detailed realization process of S101, a detailed realization process of S102 can include: when the DSP determines that the first voice signal matches the preset voice template, the DSP waking up the CPU and sending the buffered first voice signal to the CPU, thereby the CPU can extract the voiceprint of the first voice signal. It should be noted that, the voiceprint refers to sound spectrum of speech information carried by the voice. Like fingerprints, a palm shape, and irises, the voiceprint is also unique and individual biological characteristics of the human body. After the CPU extracts the voiceprint of the first voice signal, the CPU can execute voiceprint recognition to confirm whether a sound sender of the first voice signal is the user of the terminal. It can be understood that, the voiceprint recognition can identify a speaker according to the acoustic features of voices issued by the speaker, which is one of biological recognition technologies. This technique is easy to be realized, so the preset document would not give unnecessary implementation details.

S103, the terminal matches the voiceprint of the first voice signal with a preset voiceprint template.

It should be noted that, S103 can be interpreted as the process of the above-mentioned voiceprint recognition. That is, after the terminal obtains the voiceprint of the first voice signal, the terminal can determine whether the first voice signal comes from the user of the terminal according to the voiceprint.

Exemplarily, in general, the preset voiceprint template can be prestored in the terminal. Therefore, alternatively, S103 can include: the terminal matching the voiceprint of the first voice signal with the prestored voiceprint template in the terminal, and determining whether the first voice signal is from the user of the terminal according to the matching result.

However, because of the development of wireless communication technology and could technology, and limitation of storage capacity of the terminal, the preset voiceprint template can be stored in the cloud server or preset matching server with no need to be stored in the terminal itself. Therefore, alternatively, S103 can include that after the terminal sending a match request to the matching server, the terminal receives the matching result sent from the matching server. Hereinto, the match request can include the voiceprint of the first voice signal, and the matching result is obtained after the matching server matches the voiceprint of the first voice signal with the prestored voiceprint template in the matching server. It can be determined whether the first voice signal is from the user of the terminal according to the matching result from the matching server.

According to the matching result obtained in S103, if the voiceprint of the first voice signal matches the preset voiceprint template successfully, it represents that the first voice signal is from the user of the terminal. If the voiceprint of the first voice signal matches the preset voiceprint template unsuccessfully, it represents that the first voice signal is not from the user of the terminal.

S104, when the voiceprint of the first voice signal matches the preset voiceprint template successfully, the terminal generates an alarm.

Exemplarily, after matching the first voice signal with the preset voice template and voiceprint template in the steps of S102 and S103, the terminal can confirm that the user currently needs to alarm. Therefore, the terminal can generate the alarm. Concretely, the way of the alarm can include, but is not limited to, any one or more of flowing modes:

the terminal sending alarm information to a preset target terminal, and/or

the terminal obtaining current position information of the terminal, and transmitting the current position of the terminal to the preset target terminal.

Enumerations but not to limit, the preset target terminal can be relative's and friend's phone number(s) preset in advance by the user, also can be the emergence or fire telephone number according to factory default settings of the terminal.

Herein, the terminal sending alarm information to the preset target terminal include: the terminal sending an alarm message to the preset target terminal, or the terminal dials the preset target terminal.

As one implementation method, the alarm information can include information of recorded audio or video for current circumstance of the terminal. This information can be served as evidence showing that the user is in the state in which the alarm is needed.

The alarm method provided by the embodiment determines whether the user is in the state in which the alarm is needed by performing voice template matching and voiceprint template matching on the received first voice signal, and generates the alarm. The method realizes calling for help and alarm by controlling the terminal through the voice of the user, which is easy to operate, convenient, and efficient.

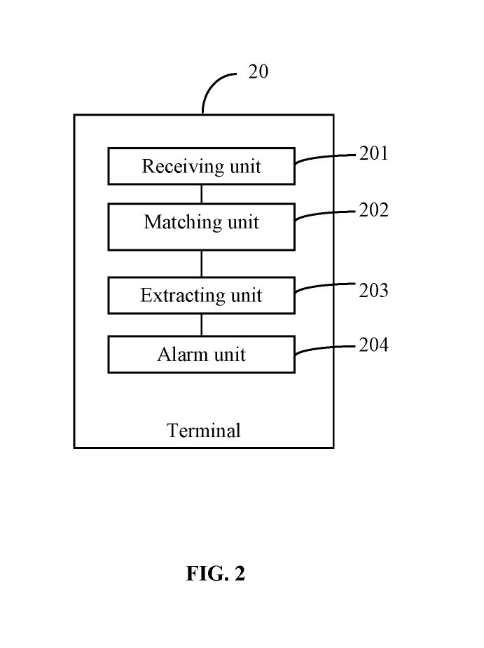

As shown in FIG. 2, it shows a structure schematic diagram of a terminal 20 provided according to an embodiment of the present document. The terminal 20 is a terminal which can realize the embodiments in FIG. 1. The terminal 20 can include a receiving unit 201, a matching unit 202, an extracting unit 203 and an alarm unit 204.

Hereinto, the receiving unit 201 is arranged to receive the first voice signal.

The matching unit 202 is arranged to match the first voice signal with a preset voice template after the receiving unit 201 receives the first voice signal.

The extracting unit 203 is arranged to extract a voiceprint of the first voice signal after the extracting unit 203 determines that the first voice signal matches the preset voice template successfully.

The matching unit 202 is further arranged to match the voiceprint of the first voice signal with a preset voiceprint template.

The alarm unit 204 is arranged to generate an alarm when the matching unit 202 determines that the voiceprint of the first voice signal matches the preset voiceprint template successfully.

Exemplarily, the preset voice template can be prestored in the terminal 20 by the user. The first voice signal can be voices or sounds issued in some specific scenes of that the user cannot operate the terminal manually. In the embodiment, the specific scenes can include, but are not limited to, the scene of the user being threatened by someone and cannot take out a mobile phone to alarm, the scene of the user having accidental injury resulted in that hands of the user cannot move, and so on. In theses specific scenes, because the user cannot use the hands to operate the terminal for alarming and calling for help, the user can only use the terminal 20 for alarming by voice controlling.

As one implementation, in the embodiment, the receiving unit 20 can be implemented by using DSP for controlling the microphone to listen to the first voice signal, and buffering the first voice signal.

The implementation of the matching unit 202 which matches the first voice signal to the preset voice template can be that the DSP is used to extract help content included in the first voice signal by the way of pattern recognition, and to match the extracted help content with the preset voice template. It can be understood that, when the match fails, the DSP would ignore the received voice signal at this time, and make the microphone continue listening.

Exemplarily, the extracting unit 203 can be realized by a CPU. When the DSP determines that the first voice signal matches the preset voice template, the DSP waking up the CPU and sending the buffered first voice signal to the CPU, so that the CPU can extract the voiceprint of the first voice signal. It should be noted that, the voiceprint refers to sound spectrum of speech information carried by the voice. Like fingerprints, a palm shape, and irises, the voiceprint is unique and individual biological characteristics of the human body. After the CPU extracts the voiceprint of the first voice signal, the CPU can execute voiceprint recognition to confirm whether a sound sender of the first voice signal is the user of the terminal. It can be understood that, the voiceprint recognition can identify a speaker according to the acoustic features of voices issued by the speaker, which is one of biological recognition technologies. This technology is easy to be realized. Therefore, the preset document would not give unnecessary implementation details.

Exemplarily, after the extracting unit 203 obtains the voiceprint of the first voice signal, the matching unit 202 can determine whether the first voice signal comes from the user of the terminal according to the voiceprint.

Exemplarily, in general, the preset voiceprint template can be prestored in the terminal 20. Therefore, as one implementation, the matching nit 202 can be further arranged to match the voiceprint of the first voice signal with the prestored voiceprint template, and determine whether the first voice signal is from the user of the terminal according to the matching result.

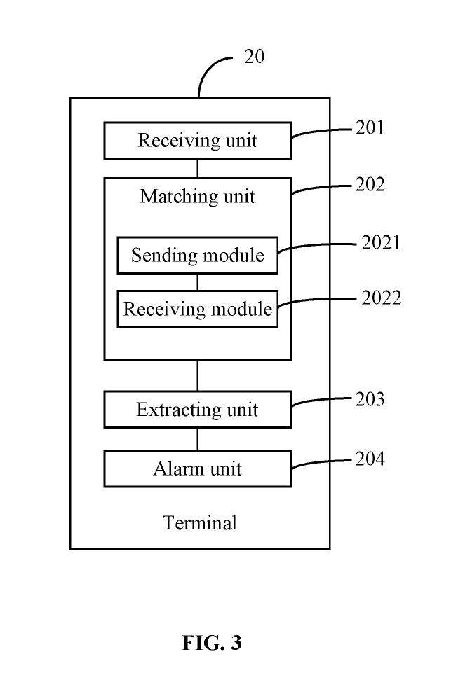

However, because of the development of wireless technology and could technology, and limitation of storage capacity of the terminal, the preset voiceprint template can be stored in the cloud server or preset matching server with no need of on the terminal 20 itself. Therefore, alternatively, as shown in FIG. 3, the matching unit 202 can include a sending module 2021 and a receiving module 2022. The sending module 2021 is arranged to send a match request to a matching server, the match request can include the voiceprint of the first voice signal.

The receiving module 2022 is arranged to receive a matching result sent from the matching server. The matching result is obtained after the matching server matches the voiceprint of the first voice signal with the prestored voiceprint template in the matching server. The matching unit 202 can determine whether the first voice signal is from the user of the terminal 20 according to the matching result from the matching server.

It can be understood that, if the voiceprint of the first voice signal matches the preset voiceprint template successfully, it represents that the first voice signal is from the user of the terminal. If the voiceprint of the first voice signal matches the preset voiceprint template unsuccessfully, it represents that the first voice signal is not from the user of the terminal.

Exemplarily, after the matching unit 202 matches the first voice signal with the preset voice template and voiceprint template successfully, the terminal 20 can confirm that the user is in the state in which alarm is needed. Therefore, the alarm unit 204 can be triggered to generate an alarm. Specifically, the alarm unit 204 can be further arranged to:

send alarm information to a preset target terminal;

and/or obtain current position information of the terminal, and transmitting the current position of the terminal to the preset target terminal.

Enumerations but not to limit, the preset target terminal can be relative's and friend's phone number(s) preset in advance by the user, also can be the emergence or fire telephone number according to factory default settings of the terminal.

Herein, the alarm unit 204 sending the alarm information to the preset target terminal comprises that the alarm unit 204 sending an alarm message to the preset target terminal, or the alarm unit 204 dialing the preset target terminal.

In one implementation, the alarm information can include information of recorded audio and/or video for current circumstance of the terminal. This information is served as evidence showing that the user is in the state in which alarm is needed.

The terminal 20 provided by the embodiments determines whether the user is in the state in which the alarm is needed by the matching unit performing voice template matching and voiceprint template matching on the received first voice signal received by the receiving unit and generates the alarm through the alarm unit. The terminal is realized to be controlled to call for help and alarm through voice of the user, which is easy to operate, convenient, and efficient.

A storage medium is further provided according to an embodiment of the present document. The storage medium stores computer programs. The computer programs are arranged to execute the alarm method in the above-mentioned embodiments.

Those skilled in the art should understand that embodiments of the present document can provide a method, system or computer program product. Therefore, the present document can be implemented in a form of hardware, a form of software or a form of combination of software and hardware. Moreover, the present document can adopt a form of a computer program product capable of being implemented on one or more computer available storage media (including but not limited to disk memory, optical memory, etc.) containing computer available program codes.

The present document is described with reference to flowchart illustrations and/or block diagrams of methods, apparatus (systems) and computer program products according to embodiments of the document. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on computer or other programmable apparatus provide process for implementing the functions/acts specified in the flowchart and/or block diagram block or blocks.

Accordingly, embodiments of the present document also provide a computer storage medium in which a computer program is stored, where the computer program is used for executing the photographing processing method in embodiments of the present document.

The above descriptions are merely preferred embodiments of the present document, but are not intended to limit the protection scope of the present document.

### INDUSTRIAL APPLICATION

The present document determines whether the user is in the state in which the alarm is needed by performing voice template matching and voiceprint template matching on the received first voice signal by the terminal, and generates the alarm, which realizes calling for help and alarm by controlling the terminal through the voice of the user, being easy to operate, convenient, and efficient.

What is claimed is:

1. An alarm method, comprising:
after receiving by a terminal a first voice signal, matching by the terminal the first voice signal with a preset voice template;
when the first voice signal matches the preset voice template successfully, extracting by the terminal a voiceprint of the first voice signal;
matching by the terminal the voiceprint of the first voice signal with a preset voiceprint template; and
when the voiceprint of the first voice signal matches the preset voiceprint template successfully generating by the terminal an alarm.

2. The method according to claim 1, wherein matching by the terminal the voiceprint of the first voice signal with a preset voiceprint template comprises:
matching by the terminal the voiceprint of the first voice signal with a voiceprint template prestored in the terminal; or
after sending a matching request to a matching server, receiving by the terminal a matching result sent from the matching server, wherein the matching request comprises the voiceprint of the first voice signal and the matching result is obtained after the matching server matches the voiceprint of the first voice signal with a voiceprint template prestored in the matching server.

3. The method according to claim 1, wherein generating by the terminal the alarm comprises:
sending by the terminal alarm information to a preset target terminal; and/or
obtaining by the terminal current position information of the terminal and transmitting the current position information to the preset target terminal.

4. The method according to claim 3, wherein sending by the terminal the alarm information to the preset target terminal comprises:
sending by the terminal an alarm message to the preset target terminal; or
dialing by the terminal the preset target terminal.

5. The method according to claim 3, wherein the alarm information comprises
information about recorded audio or video for current circumstance of the terminal.

6. A terminal, comprising a receiving unit, a matching unit, an extracting unit and an alarm unit, wherein
the receiving unit is arranged to receive a first voice signal;
the matching unit is arranged to match the first voice signal with a preset voice template after the receiving unit has received the first voice signal;
the extracting unit is arranged to extract a voiceprint of the first voice signal, when the matching unit determines that the first voice signal matches the preset voice template successfully;
the matching unit is further arranged to match the voiceprint of the first voice signal extracted by the extracting unit with a preset voiceprint template; and
the alarm unit is arranged to generate an alarm when the matching unit determines that the voiceprint of the first voice signal matches the preset voiceprint template successfully.

7. The terminal according to claim 6, wherein the matching unit is arranged to match the voiceprint of the first voice signal with a voiceprint template prestored in the terminal; or
the matching unit comprises a sending module and a receiving module; wherein:
the sending module is arranged to send a matching request to a matching server, the matching request comprising the voiceprint of the first voice signal, and
the receiving module is arranged to receive a matching result sent from the matching server, and the matching result being obtained after the matching server matches the voiceprint of the first voice signal with a voiceprint template prestored in the matching server.

8. The terminal according to claim 6, wherein the alarm unit is arranged to:
send alarm information to a preset target terminal; and/or
obtain current position information of the terminal and transmit the current position information of the terminal to the preset target terminal.

9. The terminal according to claim 8, wherein the alarm unit is arranged to:
send an alarm message to the preset target terminal or dial the preset target terminal.

10. The terminal according to claim 8, wherein the alarm information comprises information about recorded audio or video for current circumstance of the terminal.

11. A storage medium, the storage medium storing a computer program arranged for executing the alarm method of claim 1.

12. A storage medium, the storage medium storing a computer program arranged for executing the alarm method of claim 2.

13. A storage medium, the storage medium storing a computer program arranged for executing the alarm method of claim 3.

14. A storage medium, the storage medium storing a computer program arranged for executing the alarm method of claim 4.

15. A storage medium, the storage medium storing a computer program arranged for executing the alarm method of claim 5.
